(19) United States
(12) Patent Application Publication
(10) Pub. No.: US 2014/0067854 A1
(43) Pub. Date: Mar. 6, 2014

(54) CRAWLING OF GENERATED SERVER-SIDE CONTENT

(71) Applicant: International Business Machines Corporation, Armonk, NY (US)

(72) Inventors: Mathieu Jerome Simon, Kanata (CA); Iosif Viorel Onut, Kanata (CA)

(73) Assignee: International Business Machines Corporation, Armonk, NY (US)

(21) Appl. No.: 13/961,263

(22) Filed: Aug. 7, 2013

(30) Foreign Application Priority Data
Aug. 28, 2012 (CA) 2788100

(51) Int. Cl. G06F 17/30

(52) U.S. Cl. CPC G06F 17/30864
USPC 707/769

(57) ABSTRACT

Selective processing of items having embedded delay actions includes receiving an item to process containing a delay action, processing the item using a delay action process, wherein the delay action process includes exploring dynamically generated server-side content of the item received, by recognizing when a wait occurs for a server process, and performing one of a wait for a predetermined period of time, or circumventing an actual wait, to generate a result and returns the result to a requester.

### CROSS-REFERENCE TO RELATED APPLICATIONS

This application claims the benefit of Canada Application Number 2788100 filed on Aug. 28, 2012, which is fully incorporated herein by reference.

### BACKGROUND

The intrinsic nature of a webpage requires code executed at a client side, in the web browser, to wait for a web server response. Typically the client side does not need to wait for a long period of time for the content to arrive from the server. However, there are situations requiring a longer waiting time, including for example, generation of a report, processing of the data entered by the user, and locating information required for the response.

In cases where a longer waiting time is evident, web designers typically use a visual representation of the waiting time in a text or graphical form, such as a waiting bar, a message displayed to the user, or simply an image of a clock, or other visual cue. The visual representation enables the user to understand that content is currently being processed and generated by the website, and the user needs to wait for processing to finish.

In contrast, a web crawler is not able to detect whether an operation is in progress unless the web crawler examines code for the page and uses a strategy to understand the code is waiting for the user response. In these situations, to automatically explore the dynamically generated server-side web content, a web crawler would need to understand when the client waits for the server, and do the same.

There are, however, alternative methods enabling the user to record user actions. Throughout such recording, the crawler could monitor generated hypertext transport protocol (HTTP) traffic and extract content from the traffic. A disadvantage of this method is a need for user input. In addition, depending on implementation, an additional disadvantage may arise due to not analyzing the content returned by the web server in the context of the current page.

### BRIEF SUMMARY

According to one embodiment, a computer-implemented process for selective processing of items having embedded delay actions includes receiving an item to process containing a delay action, processing the item using a delay action process using a processor, wherein the delay action process includes exploring dynamically generated server-side content of the item received, by recognizing when a wait occurs for a server process, and performing one of a wait for a predetermined period of time, or circumventing an actual wait, to generate a result and returns the result to a requester.

According to another embodiment, a computer program product for selective processing of items having embedded delay actions includes a computer recordable storage media containing computer program code stored thereon. The computer program code is executable by a processor to perform a method. The method includes receiving, using the processor, an item to process containing a delay action, processing, using the processor, the item using a delay action process, wherein the delay action process includes exploring dynamically generated server-side content of the item received, by recognizing when a wait occurs for a server process, and performing, using the processor, one of a wait for a predetermined period of time, or circumventing an actual wait, to generate a result, and returning, using the processor, the result to a requester.

According to another embodiment, a system for selective processing of items having embedded delay actions includes a processor programmed to initiate executable operations. The executable operations include receiving an item to process containing a delay action, processing the item using a delay action process, wherein the delay action process includes exploring dynamically generated server-side content of the item received, by recognizing when a wait occurs for a server process, and performing one of a wait for a predetermined period of time, or circumventing an actual wait, to generate a result and returning the result to a requester.

### BRIEF DESCRIPTION OF THE SEVERAL VIEWS OF THE DRAWINGS

For a more complete understanding of this disclosure, reference is now made to the following brief description, taken in conjunction with the accompanying drawings and detailed description, wherein like reference numerals represent like parts.

FIG. 1 is a block diagram of an exemplary network data processing system operable for various embodiments of the disclosure;

FIG. 2 is a block diagram of an exemplary data processing system operable for various embodiments of the disclosure;

FIG. 3 is a block diagram of a system operable for various embodiments of the disclosure;

FIG. 4 is a block diagram of screenshots in accordance with one embodiment of the disclosure;

FIG. 5 is a flowchart of delay action processing using the system of FIG. 3 operable for various embodiments of the disclosure;

FIG. 6 is a flowchart of a hybrid process using the delay action processing of FIG. 5 operable for various embodiments of the disclosure; and

FIG. 7 is a flowchart of an alternative embodiment of the hybrid process of FIG. 6 operable for various embodiments of the disclosure.

### DETAILED DESCRIPTION

This disclosure relates generally to rich Internet applications in a data processing system and more specifically to Web applications using scripting in the data processing system.

Although an illustrative implementation of one or more embodiments is provided below, the disclosed systems and/or methods may be implemented using any number of techniques. This disclosure should in no way be limited to the illustrative implementations, drawings, and techniques illustrated below, including the exemplary designs and implementations illustrated and described herein, but may be modified within the scope of the appended claims along with their full scope of equivalents.

As will be appreciated by one skilled in the art, aspects of the present disclosure may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module,” or “system.” Furthermore, aspects of the present invention may take the form of a computer program product embodied in one or more computer readable medium(s) having computer readable program code, instructions, embodied thereon.

Any combination of one or more computer-readable data storage medium(s) may be utilized. A computer-readable data storage medium may be, for example, but not limited to, an electronic, magnetic, optical, or semiconductor system, apparatus, or device, or any suitable combination of the foregoing. More specific examples (a non-exhaustive list) of the computer-readable data storage medium would include the following: a portable computer diskette, a hard disk, a random access memory (RAM), a read-only memory (ROM), an erasable programmable read-only memory (EPROM or Flash memory), a portable compact disc read-only memory (CDROM), an optical storage device, or a magnetic storage device or any suitable combination of the foregoing. In the context of this document, a computer-readable data storage medium may be any tangible medium that can contain, or store a program for use by or in connection with an instruction execution system, apparatus, or device.

A computer-readable signal medium may include a propagated data signal with the computer-readable program code embodied therein, for example, either in baseband or as part of a carrier wave. Such a propagated signal may take a variety of forms, including but not limited to electro-magnetic, optical or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer-readable medium may be transmitted using any appropriate medium, including but not limited to wireless, wire line, optical fiber cable, RF, etc. or any suitable combination of the foregoing.

Computer program code for carrying out operations for aspects of the present disclosure may be written in any combination of one or more programming languages, including an object oriented programming language such as Java®, Smalltalk, C++, or the like and conventional procedural programming languages, such as the “C” programming language or similar programming languages. Java and all Java-based trademarks and logos are trademarks of Oracle, and/or its affiliates, in the United States, other countries or both. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described below with reference to flowchart illustrations and/or block diagrams of methods, apparatus, (systems), and computer program products according to embodiments of the invention. It will be understood that each block of the flowchart illustrations and/or block diagrams, and combinations of blocks in the flowchart illustrations and/or block diagrams, can be implemented by computer program instructions.

These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer or other programmable data processing apparatus to function in a particular manner, such that the instructions stored in the computer readable medium produce an article of manufacture including instructions which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide processes for implementing the functions/acts specified in the flowchart and/or block diagram block or blocks.

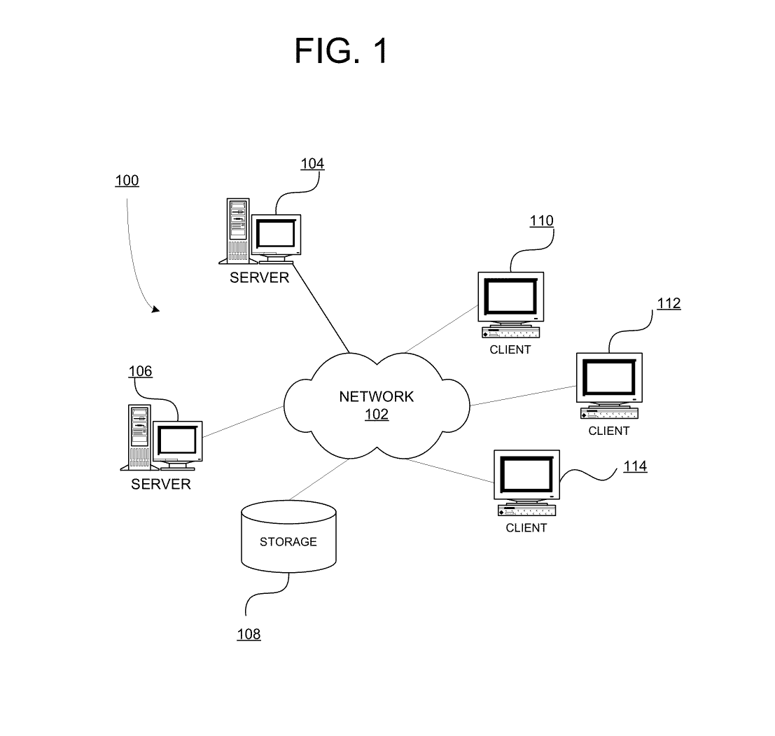

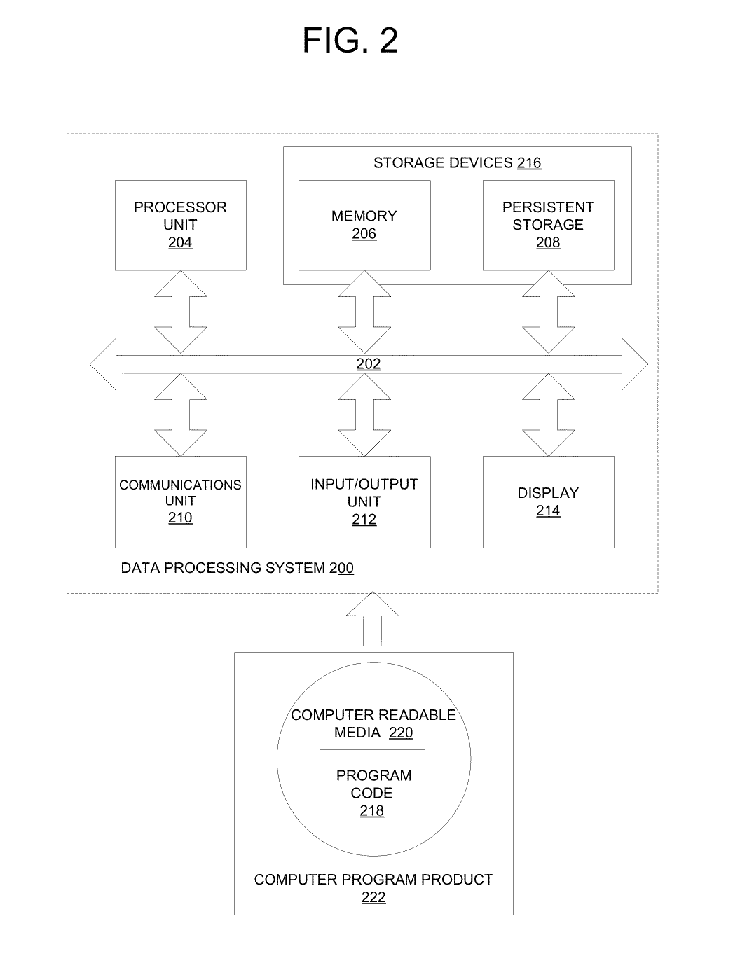

With reference now to the figures and in particular with reference to FIGS. 1-2, exemplary diagrams of data processing environments are provided in which illustrative embodiments may be implemented. It should be appreciated that FIGS. 1-2 are only exemplary and are not intended to assert or imply any limitation with regard to the environments in which different embodiments may be implemented. Many modifications to the depicted environments may be made.

FIG. 1 depicts a pictorial representation of a network of data processing systems in which illustrative embodiments may be implemented. Network data processing system 100 is a network of computers in which the illustrative embodiments may be implemented. Network data processing system 100 contains network 102, which is the medium used to provide communications links between various devices and computers connected together within network data processing system 100. Network 102 may include connections, such as wire, wireless communication links, or fiber optic cables.

In the depicted example, server 104 and server 106 connect to network 102 along with storage unit 108. In addition, clients 110, 112, and 114 connect to network 102. Clients 110, 112, and 114 may be, for example, personal computers or network computers. In the depicted example, server 104 provides data, such as boot files, operating system images, and applications to clients 110, 112, and 114. Clients 110, 112, and 114 are clients to server 104 in this example. Network data processing system 100 may include additional servers, clients, and other devices not shown.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the different illustrative embodiments.

With reference to FIG. 2 a block diagram of an exemplary data processing system operable for various embodiments of the disclosure is presented. In this illustrative example, data processing system 200 includes communications fabric 202, which provides communications between processor unit 204, memory 206, persistent storage 208, communications unit 210, input/output (I/O) unit 212, and display 214.

Processor unit 204 serves to execute instructions for software that may be loaded into memory 206. Processor unit 204 may be a set of one or more processors or may be a multi-processor core, depending on the particular implementation. Further, processor unit 204 may be implemented using one or more heterogeneous processor systems in which a main processor is present with secondary processors on a single chip. As another illustrative example, processor unit 204 may be a symmetric multi-processor system containing multiple processors of the same type.

Memory 206 and persistent storage 208 are examples of storage devices 216. A storage device is any piece of hardware that is capable of storing information, such as, for example without limitation, data, program code in functional form, and/or other suitable information either on a temporary basis and/or a permanent basis. Memory 206, in these examples, may be, for example, a random access memory or any other suitable volatile or non-volatile storage device. Persistent storage 208 may take various forms depending on the particular implementation. For example, persistent storage 208 may contain one or more components or devices. For example, persistent storage 208 may be a hard drive, a flash memory, a rewritable optical disk, a rewritable magnetic tape, or some combination of the above. The media used by persistent storage 208 also may be removable. For example, a removable hard drive may be used for persistent storage 208.

Communications unit 210, in these examples, provides for communications with other data processing systems or devices. In these examples, communications unit 210 is a network interface card. Communications unit 210 may provide communications through the use of either or both physical and wireless communications links.

Input/output unit 212 allows for input and output of data with other devices that may be connected to data processing system 200. For example, input/output unit 212 may provide a connection for user input through a keyboard, a mouse, and/or some other suitable input device. Further, input/output unit 212 may send output to a printer. Display 214 provides a mechanism to display information to a user.

Instructions for the operating system, applications and/or programs may be located in storage devices 216, which are in communication with processor unit 204 through communications fabric 202. In these illustrative examples the instructions are in a functional form on persistent storage 208. These instructions may be loaded into memory 206 for execution by processor unit 204. The processes of the different embodiments may be performed by processor unit 204 using computer-implemented instructions, which may be located in a memory, such as memory 206.

These instructions are referred to as program code, computer usable program code, or computer readable program code that may be read and executed by a processor in processor unit 204. The program code in the different embodiments may be embodied on different physical or tangible computer readable storage media, such as memory 206 or persistent storage 208.

Program code 218 is located in a functional form on computer readable storage media 220 that is selectively removable and may be loaded onto or transferred to data processing system 200 for execution by processor unit 204. Program code 218 and computer readable storage media 220 form computer program product 222 in these examples. In one example, computer readable storage media 220 may be in a tangible form, such as, for example, an optical or magnetic disc that is inserted or placed into a drive or other device that is part of persistent storage 208 for transfer onto a storage device, such as a hard drive that is part of persistent storage 208. In a tangible form, computer readable storage media 220 also may take the form of a persistent storage, such as a hard drive, a thumb drive, or a flash memory that is connected to data processing system 200. The tangible form of computer readable storage media 220 is referred to as “computer recordable storage media”. In some instances, computer readable storage media 220 may not be removable.

Alternatively, program code 218 may be transferred to data processing system 200 from computer readable storage media 220 through a communications link to communications unit 210 and/or through a connection to input/output unit 212. The communications link and/or the connection may be physical or wireless in the illustrative examples. The computer readable media also may take the form of non-tangible media, such as communications links or wireless transmissions containing the program code.

In some illustrative embodiments, program code 218 may be downloaded over a network to persistent storage 208 from another device or data processing system for use within data processing system 200. For instance, program code stored in a computer readable storage medium in a server data processing system may be downloaded over a network from the server to data processing system 200. The data processing system providing program code 218 may be a server computer, a client computer, or some other device capable of storing and transmitting program code 218.

Using data processing system 200 of FIG. 2 as an example, a computer-implemented process for selective processing of items having embedded delay actions is presented. Processor unit 204 receives an item to process containing a delay action. Processor unit 204 processes the item using a delay action process, wherein the delay action process includes exploring dynamically generated server-side content of the item received, by recognizing when a wait occurs for a server process. Processor unit 204 performs one of a wait for a predetermined period of time, or circumventing an actual wait, to generate a result. Processor unit 204 returns the result to a requester.

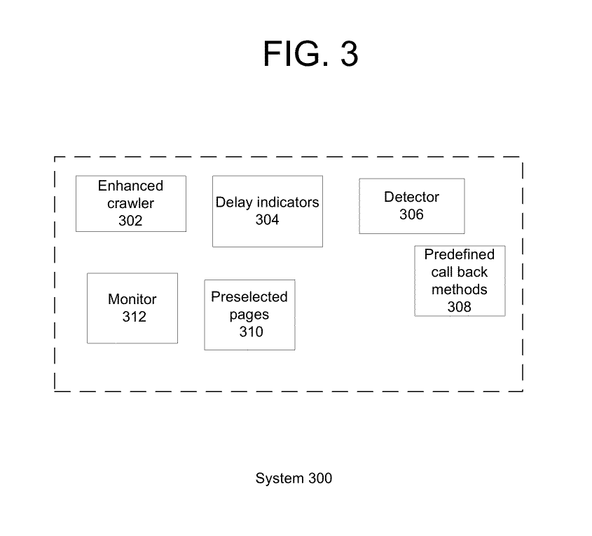

With reference to FIG. 3 a block diagram of a system operable for various embodiments of the disclosure is presented. System 300 is an example of a processing system providing a capability of programmatically processing progress pages enabling automated crawling of server side generated content.

System 300 comprises a number of components leveraging support of an underlying data processing system for example, network data processing system 100 of FIG. 1 and/or data processing 200 of FIG. 2. System 300 may be implemented in various manners including a set of discrete components functioning as a logical unit or a single unit without comprising functionality provided. For example, system 300 may be implemented as a replacement for an existing web crawler or as extensions to an existing web crawler processing environment. In alternative implementations, the example using system 300 is not meant to be a limitation as the disclosed process may also be implemented in other environments such as a search process augmentation.

System 300 includes functional units comprising enhanced crawler 302, delay indicators 304, detector 306, predefined callback methods 308, preselected pages 310 and monitor 312.

Enhanced crawler 302 is an example of a processor providing a capability of analyzing an item, in the current example, a web page, to determine and manage progress pages to enable programmatic processing of server-side content. For example, using an embodiment of system 300, enhanced crawler 302, is able to programmatically explore dynamically generated server-side web content, by recognizing when a client waits for the server, and do the same, or circumvent the actual wait and continue to process.

Delay indicators 304 are predefined identifiers associated with a function or operation, which results in a delay in receiving a server-side response. For example, when using a scripting language such as JavaScript™ (JavaScript is a trademark of Oracle Corporation), an example of a delay indicator is a setTimeout call. Delay indicators are identified in respective items to be processed to enable proper scanning and processing of the items.

Detector 306 provides a capability to identify a particular server-side technology is used in association with an item to be processed. For example, detector 306 may be used to identify the server side technology of asp.net, for example via http header, and assuming common server callback methods used by the framework. Once detected and identified the server side technology typically is used to identify associated delay indicators.

Predefined callback methods 308 provide a capability to a user to pre-identify server callback methods, enabling the system to not rely on absolute timeout, and accordingly to typically improve scanning speed as a result. For example, provision of the predefined callbacks would enable the system to avoid using detector 306 to identify a server side technology and associated delay indicators, thereby reducing process resources and time to provide a result.

Preselected pages 310 are maintained in a data structure containing items, in the current web crawler example web pages, which contain delaying indicators. Items previously identified by a user of the system enable the system to avoid processing all items to identify a subset of items having the delay indicators. When not provided the system must process all items to determine whether delay indicators exist and accordingly incur extra processing overhead.

Monitor 312 provides a capability to monitor or track calls made to a specific routine for example, when a function is called using a scripting language, monitor calls to XMLHttpRequest.open( ) and/or frame navigation is being called. When the calls do not occur, the system assumes a delay indicator such as a setTimeout call is not used for server-side content processing.

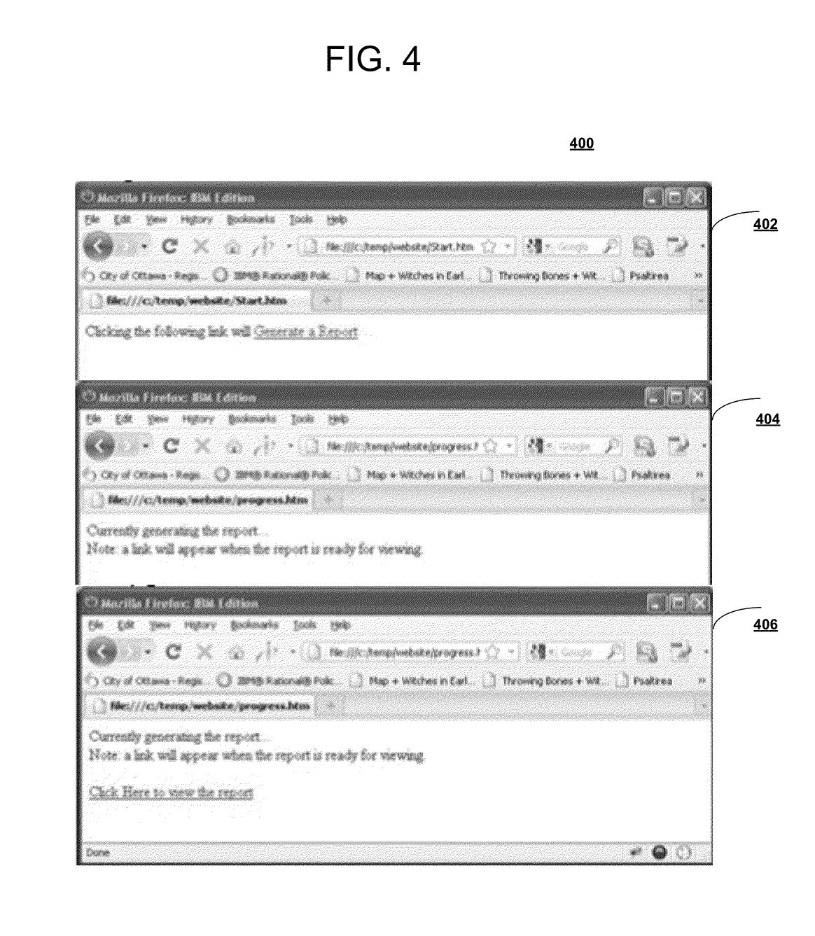

With reference to FIG. 4 a block diagram of screenshots operable for various embodiments of the disclosure is presented. Screenshots 400 are an example of visual cues provided indicating a delay in processing while an operation is in progress.

Page 402 provides an example of a screen prompting a user to select an operation. The server is awaiting a user response at this time. Page 404 provides an example of when the server is busy responding to the user request from page 402. The response indicates a user is to await a response. Page 406 is an example of a screen prompting a user to select an operation in response to completing processing associated with the previous user request.

In each case a delay is encountered, either due to a wait for user input or to a server operation in progress. Different causes of delay may be detected and processed programmatically by an enhanced crawler of the disclosure.

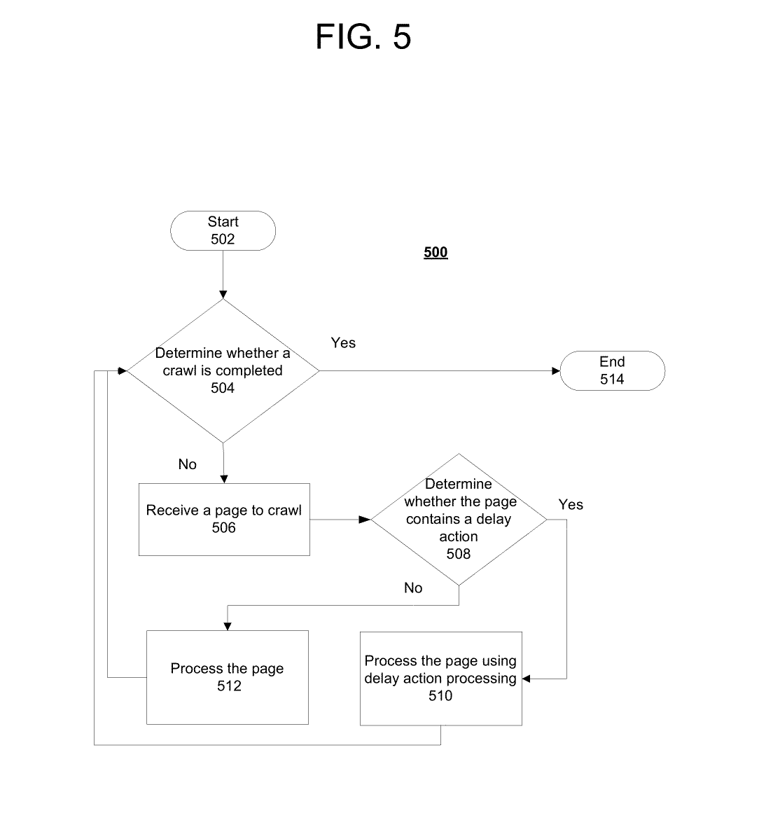

With reference to FIG. 5 a flowchart of delay action processing operable for various embodiments of the disclosure is presented. Process 500 is an example of a process using system 300 of FIG. 3.

In the example, process 500 proposes additional sub-processes as compared with conventional processing of a crawler. In a first sub-process programmatic identification of those web pages that require the client side to wait for the server side processing to be finished is performed to identify pages requiring additional processing. In a second sub-process an enhanced crawling technique for those types of identified pages is used.

Process 500 receives an item to process containing a delay action and processes the item using a delay action process, wherein the delay action process includes exploring dynamically generated server-side content of the item received, by recognizing when a wait occurs for a server process, and performing one of a wait for a predetermined period of time, or circumventing an actual wait, to generate a result. Process 500 returns the result to a requester. In the current example the item is a web page and the process is a web crawler. The delay action may be a specified timeout function as used in the programming language of the page or may be representative of another known cause of delay including, for example, a frame navigation call.

Process 500 begins (step 502) and determines whether a crawl is completed (step 504). Responsive to a determination the crawl is completed, process 500 terminates (step 514). Responsive to a determination the crawl is not completed, process 500 receives a page to crawl (step 506).

Process 500 determines whether the page contains a delay action (step 508). For example, the crawler must search for specific delayed actions (for example, JavaScript has a setTimeout(function, timeout) method call) in the body of the received page to crawl. All the pages identified as containing these types of calls need to be handled using delay action processing.

Responsive to a determination the page does not contain delay actions, process 500 processes the page in a conventional manner (step 512) and returns to step 504 for continued processing as before. Responsive to a determination the page does not contain delay actions; process 500 processes the page using delay action processing for the page including attempting to not wait for the timeout, but to compare the document object models (DOMs) representative of the page before and after executing a function associated with the timeout. When the DOMs are the same, process 500 waits the same amount of time as specified in the timeout. The wait enables the web server to finish a task in progress. After the timeout expires, process 500 executes the associated function, compares the DOMs again and crawls the differences.

Process 500 does not require user input. Process 500 when attempting to bypass the defined timeout, if not successful, process 500 simulates a real waiting time, to enable a process on a web server (in the example) to catch up. Embodiments in the current example refer to web applications using JavaScript on the client side. However, the embodiments can be potentially generalized to other types of processing including rich Internet applications and search applications.

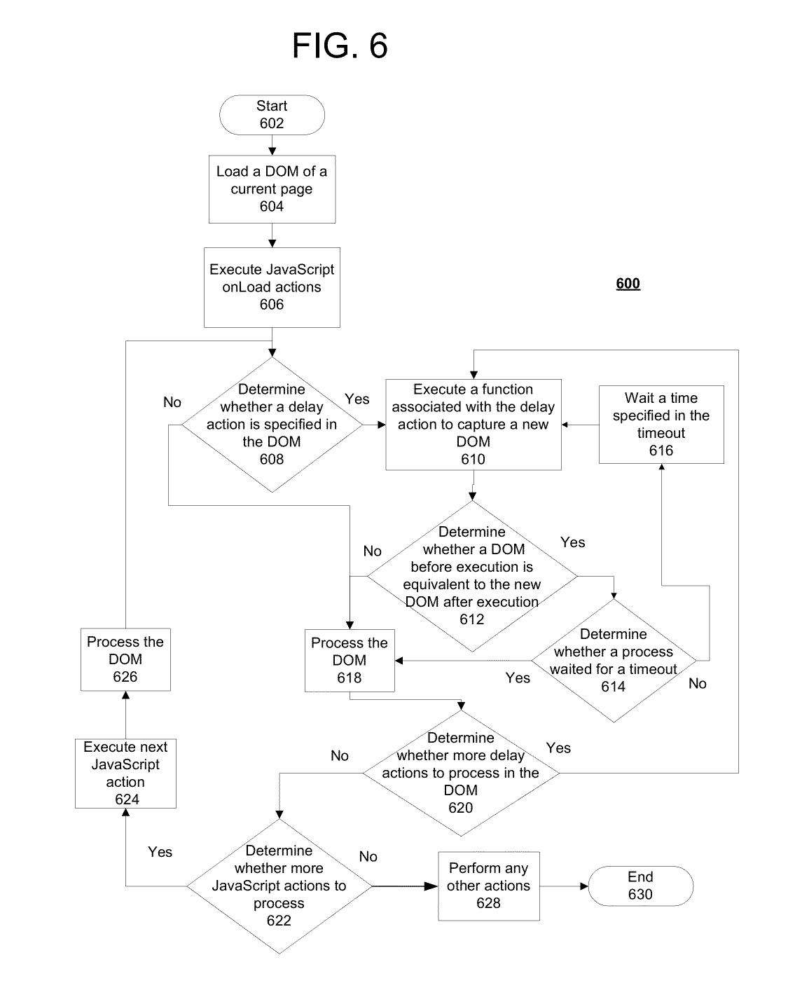

With reference to FIG. 6 a flowchart of hybrid processing using delay action processing operable for various embodiments of the disclosure is presented. Process 600 is a detailed example of an embodiment using the process of system 300 of FIG. 3 and the delay process of FIG. 5.

Generally speaking, there are two sections in the flowchart of process 600. An outer section depicts processing in an example applicable to a regular crawler including steps 602-606 and 622-630. In the conventional processing, process 600 performs loading of the DOM of the page, executing the onLoad event (an event handler triggered after a item has been loaded, such as a web page in this example) and also execute all the other JavaScript events on the page in process. The enhancement to the conventional process therefore includes processing including steps 608-620 to produce a hybrid process or simply an enhanced process.

Process 600 begins (step 602) and loads a DOM of a current page (step 604). Process 600 executes JavaScript onLoad actions (step 606). The enhanced portion is executed after onLoad of the page and also after the execution of any JavaScript action on the page. The execution of the portion of process 600 in this manner accommodates dynamic pages for example those created for the asynchronous JavaScript and extensible markup language (XML) (AJAX) environment, where content of a page can change as a consequence of a JavaScript action.

Process 600 determines whether a delay action is specified in the DOM (step 608). The delay actions may be referred to as delayed events. For example, in an embodiment using JavaScript process 600 seeks to find setTimeout functions, as a delay action. Responsive to a determination that a delay action is specified in the DOM process 600, executes a function associated with the delay action to capture a new DOM (step 610). Process 600 determines whether the DOM before execution is equivalent to the DOM after the execution of the associated function (step 612).

Responsive to a determination that the DOM before execution is not equivalent to the DOM after the execution of the associated function (the DOM changes, with new content added or content is removed) process 600 processes the DOM (step 618). Process 600 determines whether more delay actions exist in the DOM (step 620). Responsive to a determination that more delay actions exist in the DOM, process 600 loops back to perform step 610 as before.

Responsive to a determination that the DOM before execution is equivalent to the DOM after the execution of the associated function, process 600 determines whether the process waited for a timeout (delay event) (step 614). Responsive to a determination that process 600 did not wait for the timeout, process 600 waits for a time specified in the timeout (step 616) and continues to process step 610 as before.

When process 600 determines the DOMs are still identical, process 600 can move on. When process 600 determines there are some differences, process 600 processes the differences as new information.

Process 600 determines whether there are more JavaScript actions to process (step 622). Responsive to a determination that there are more JavaScript actions to process 600 executes a next JavaScript action (step 624). Process 600 process the DOM (step 626) and loops back to perform step 608 as before. Responsive to a determination that there are no more JavaScript actions to process, process 600 performs any other actions (step 628) and terminates thereafter (step 630).

Processing the DOM is about extracting information required by the crawler, for the purpose of gathering data, or finding additional resources to crawl. A new DOM is a result of the delay action modifying the DOM with additional or removed content (for example, a new hyperlink is added: ‘get report’, and another hyperlink is removed: ‘cancel report generation’).

Comparing the old DOM and the new DOM is possible by keeping track of the original DOM in a form including an entirety, a compressed format, an abridged format, or by using other memory efficient algorithms. An abridged DOM format means reducing the DOM to only the elements of the DOM desired by an implementer of the crawler using either heuristics or other algorithms, to compare the DOMs as part of a crawling process. For example, comparing the old DOM and new DOM using an abridged format may lead to ignoring elements including a progress indicator, or advertisements.

Typically the new DOM created would be a slight variation of the original DOM, but nothing prevents the delay action from re-writing a brand new DOM. The implementer of the process may decide to treat the original DOM and resulting modified new DOM as two different pages and process each individually, but optimizations would typically not do so and process only the modified content, which is currently shown.

In a case where creating the new DOM removes most of the original DOM content, processing the original DOM and the modified DOM as two different pages is recommended, to not prevent the crawler from gathering data from the original DOM or finding additional resources (for example, a ‘cancel report generation’ hyperlink leads to additional content including a list of cancelled report generation requests).

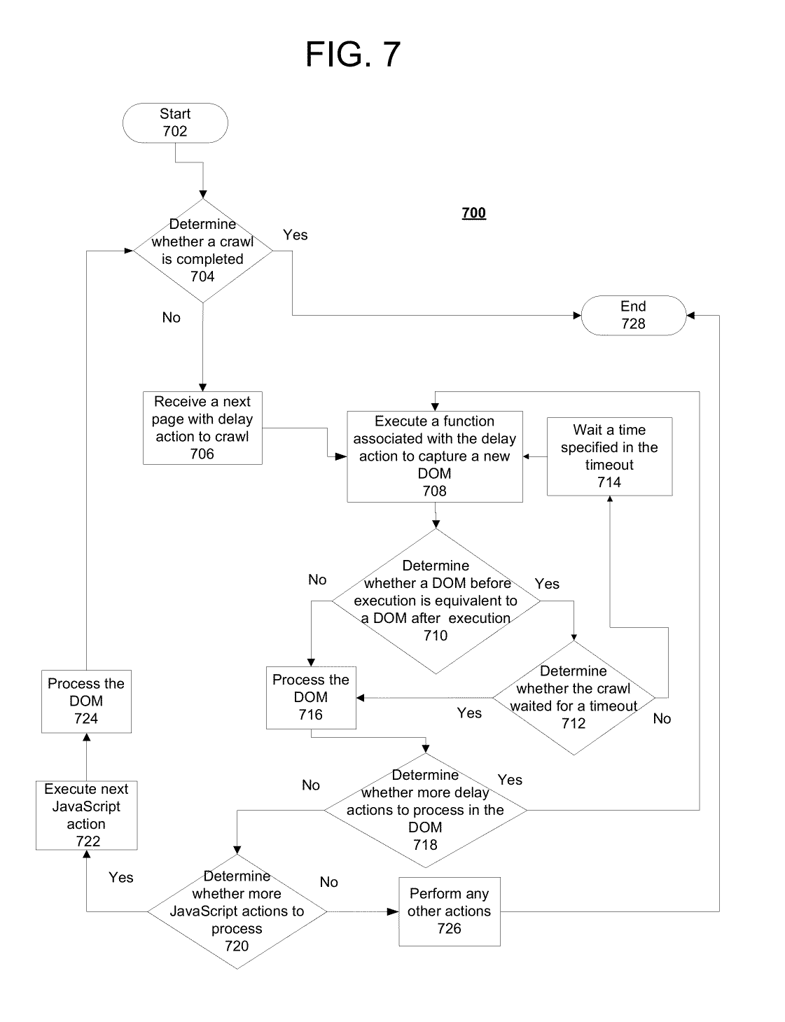

With reference to FIG. 7 a flowchart of an alternative embodiment of hybrid processing using delay action processing operable for various embodiments of the disclosure is presented. Process 700 is an alternative embodiment of process 600 of FIG. 6 using the process of system 300 of FIG. 3, in which a page or set of pages known to have one or more delay actions thereon is provided.

In this example process 700 performs loading of the DOM of the page, executing the onLoad event and also executes all the other JavaScript events on the page in process as before, however the determination of whether a delay action is specified in the DOM (previous step 608 of process 600 of FIG. 6) is avoided, thereby typically reducing processing.

Process 700 begins (step 702) and determines whether a crawl is completed (step 704). Responsive to a determination that a crawl is completed, process 700 terminates (step 728). Responsive to a determination that the crawl is not completed, process 700 receives a next page with delay action to crawl (step 706).

Process 700, executes a function associated with the delay action to capture a new DOM (step 708). Process 700 determines whether the DOM before execution is equivalent to the DOM after the execution of the associated function (step 710).

Responsive to a determination that the DOM before execution is not equivalent to the DOM after the execution of the associated function (the DOM changes, with new content added or content is removed) process 700 processes the DOM (step 716). Process 700 determines whether more delay actions exist in the DOM (step 718). Responsive to a determination that more delay actions exist in the DOM, process 700 loops back to perform step 708 as before.

Responsive to a determination that the DOM before execution is equivalent to the DOM after the execution of the associated function, process 700 determines whether the process waited for a timeout (delay event) (step 712). Responsive to a determination that process 700 did not wait for the timeout, process 700 waits for a time specified in the timeout (step 714) and continues to process step 708 as before.

When process 700 determines the DOMs are still identical, process 700 can move on. When process 700 determines there are some differences, process 700 processes the differences as new information.

Process 700 determines whether there are more JavaScript actions to process (step 720). Responsive to a determination that there are more JavaScript actions to process 700 executes a next JavaScript action (step 722). Process 700 process the DOM (step 724) and loops back to perform step 704 as before. Responsive to a determination that there are no more JavaScript actions to process, process 700 performs any other actions (step 726) and terminates thereafter (step 728).

In a similar manner, an embodiment of process 600 or process 700 may be altered to include processing in which detector 306 of system 300 of FIG. 3 is used to identify a server side technology being used and according select a predefined callback method 308 also of FIG. 3 to not rely on an absolute timeout (delay action). In another embodiment, monitor 312 of FIG. 3 can be used to monitor function calls, such as when a JavaScript call to XMLHttpRequest.open( ) and/or frame navigation is made. When no such call is indicated, the disclosed process assumes a delay action such as setTimeout is not used for server side content processing.

Thus is presented in an illustrative embodiment a computer-implemented process for selective processing of items having embedded delay actions. The computer-implemented process receives an item to process containing a delay action, processes the item using a delay action process, wherein the delay action process comprises exploring dynamically generated server-side content of the item received, by recognizing when a wait occurs for a server process, and performing one of a wait for a predetermined period of time, or circumventing an actual wait, to generate a result and returns the result to a requester.

The flowchart and block diagrams in the figures illustrate the architecture, functionality, and operation of possible implementations of systems, methods, and computer program products according to various embodiments of the present invention. In this regard, each block in the flowchart or block diagrams may represent a module, segment, or portion of code, which comprises one or more executable instructions for implementing a specified logical function. It should also be noted that, in some alternative implementations, the functions noted in the block might occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The invention can take the form of an entirely hardware embodiment, an entirely software embodiment or an embodiment containing both hardware and software elements. In a preferred embodiment, the invention is implemented in software, which includes but is not limited to firmware, resident software, microcode, and other software media that may be recognized by one skilled in the art.

It is important to note that while the present invention has been described in the context of a fully functioning data processing system, those of ordinary skill in the art will appreciate that the processes of the present invention are capable of being distributed in the form of a computer readable data storage medium having computer executable instructions stored thereon in a variety of forms. Examples of computer readable data storage media include recordable-type media, such as a floppy disk, a hard disk drive, a RAM, CD-ROMs, DVD-ROMs. The computer executable instructions may take the form of coded formats that are decoded for actual use in a particular data processing system.

A data processing system suitable for storing and/or executing computer executable instructions comprising program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modems, and Ethernet cards are just a few of the currently available types of network adapters.

What is claimed is:

1. A computer-implemented process for selective processing of items having embedded delay actions, the computer-implemented process comprising:
receiving an item to process containing a delay action;
processing the item using a delay action process using a processor, wherein the delay action process comprises exploring dynamically generated server-side content of the item received, by recognizing when a wait occurs for a server process, and performing one of a wait for a predetermined period of time, or circumventing an actual wait, to generate a result; and
returning the result to a requester.

2. The computer-implemented process of claim 1 wherein receiving an item to process containing a delay action further comprises:
loading a document object model of a current item;
executing an event handler action; and
determining whether a delay action is specified in the document object model.

3. The computer-implemented process of claim 1 wherein processing the item using a delay action process further comprises:
responsive to a determination that a delay action is specified in a document object model, executing a function associated with the delay action to capture a new document object model;
responsive to a determination that the document object model before execution of the function is equivalent to the new document object model after execution of the function, determining whether a process waited for a timeout;
responsive to a determination that the process did not wait for the timeout, waiting a time specified in the timeout;
executing the function associated with the delay action to capture the new document object model;
determining whether the document object model before execution of the function is equivalent to the new document object model after execution of the function; and
responsive to a determination that the document object model before execution of the function is not equivalent to the new document object model after execution of the function, processing the document object model.

4. The computer-implemented process of claim 1 wherein receiving an item to process containing a delay action further comprises:
receiving a preselected set of items, wherein each item contains one or more delay actions embedded therein.

5. The computer-implemented process of claim 3 further comprising:
determining whether there are more delay actions to process in the document object model;
responsive to a determination that there are no more delay actions to process in the document object model, determining whether there are more JavaScript actions to process;
responsive to a determination that there are more JavaScript actions to process, executing a next JavaScript; and
processing the document object model.

6. The computer-implemented process of claim 1 wherein receiving an item to process containing a delay action further comprises:
detecting in the item to identify a server side technology being used; and
selecting a predefined callback method according to the identified server side technology, wherein reliance on the delay action is obviated.

7. The computer-implemented process of claim 1 wherein receiving an item to process containing a delay action further comprises:
monitoring predetermined function calls to identify an item to process containing the delay action; and
assuming the delay action is not used for server side content processing when no such call is indicated.

8. A computer program product for selective processing of items having embedded delay actions, the computer program product comprising:
a computer recordable storage media containing computer program code stored thereon, wherein the computer program code is executable by a processor to perform a method comprising:
receiving, using the processor, an item to process containing a delay action;
processing, using the processor, the item using a delay action process, wherein the delay action process comprises exploring dynamically generated server-side content of the item received, by recognizing when a wait occurs for a server process, and performing one of a wait for a predetermined period of time, or circumventing an actual wait, to generate a result; and
returning, using the processor, the result to a requester.

9. The computer program product of claim 8 wherein receiving an item to process containing a delay action further comprises:
loading a document object model of a current item;
executing an event handler action; and
determining whether a delay action is specified in the document object model.

10. The computer program product of claim 8 wherein processing the item using a delay action process further comprises:
responsive to a determination that a delay action is specified in a document object model, executing a function associated with the delay action to capture a new document object model;
responsive to a determination that the document object model before execution of the function is equivalent to the new document object model after execution of the function, determining whether a process waited for a timeout;
responsive to a determination that the process did not wait for the timeout, waiting a time specified in the timeout;
executing the function associated with the delay action to capture the new document object model;
determining whether the document object model before execution of the function is equivalent to the new document object model after execution of the function; and
responsive to a determination that the document object model before execution of the function is not equivalent to the new document object model after execution of the function, processing the document object model.

11. The computer program product of claim 8 wherein receiving an item to process containing a delay action further comprises:
receiving a preselected set of items, wherein each item contains one or more delay actions embedded therein.

12. The computer program product of claim 10 wherein the method further comprises:
determining whether there are more delay actions to process in the document object model;
responsive to a determination that there are no more delay actions to process in the document object model, determining whether there are more JavaScript actions to process;
responsive to a determination that there are more JavaScript actions to process, executing a next JavaScript; and
processing the document object model.

13. The computer program product of claim 8 wherein receiving an item to process containing a delay action further comprises:
detecting in the item to identify a server side technology being used; and
selecting a predefined callback method according to the identified server side technology, wherein reliance on the delay action is obviated.

14. The computer program product of claim 8 wherein receiving an item to process containing a delay action further comprises:
monitoring predetermined function calls to identify an item to process containing the delay action; and
assuming the delay action is not used for server side content processing when no such call is indicated.

15. A system for selective processing of items having embedded delay actions, the apparatus comprising:
a processor programmed to initiate executable operations comprising:
receiving an item to process containing a delay action;
processing the item using a delay action process, wherein the delay action process comprises exploring dynamically generated server-side content of the item received, by recognizing when a wait occurs for a server process, and performing one of a wait for a predetermined period of time, or circumventing an actual wait, to generate a result; and
returning the result to a requester.

16. The system of claim 15 wherein receiving an item to process containing a delay action further comprises:
loading a document object model of a current item;
executing an event handler action; and
determining whether a delay action is specified in the document object model.

17. The system of claim 15 wherein processing the item using a delay action process further comprises:
responsive to a determination that a delay action is specified in a document object model, executing a function associated with the delay action to capture a new document object model;
responsive to a determination that the document object model before execution of the function is equivalent to the new document object model after execution of the function, determining whether a process waited for a timeout;
responsive to a determination that the process did not wait for the timeout, waiting a time specified in the timeout;
executing the function associated with the delay action to capture the new document object model;
determining whether the document object model before execution of the function is equivalent to the new document object model after execution of the function;
responsive to a determination that the document object model before execution of the function is not equivalent to the new document object model after execution of the function, processing the document object model.

18. The system of claim 15 wherein receiving an item to process containing a delay action further comprises:
receiving a preselected set of items, wherein each item contains one or more delay actions embedded therein.

19. The system of claim 17 wherein the processor is further programmed to initiate executable operations comprising:
determining whether there are more delay actions to process in the document object model;
responsive to a determination that there are no more delay actions to process in the document object model, determining whether there are more JavaScript actions to process;
responsive to a determination that there are more JavaScript actions to process, executing a next JavaScript; and
processing the document object model.

20. The system of claim 15 wherein receiving an item to process containing a delay action further comprises:
detecting in the item a server side technology being used; and
selecting a predefined callback method according to the identified server side technology, wherein reliance on the delay action is obviated.
